(19) United States
(12) Patent Application Publication
(10) Pub. No.: US 2012/0172110 A1
(43) Pub. Date: Jul. 5, 2012

(54) 7 Cards Poker-Mahjong Video Game

(76) Inventor: James D. Chen, Granada Hills, CA (US)

(21) Appl. No.: 12/981,177

(22) Filed: Dec. 29, 2010

(51) Int. Cl. A63F 13/00

(52) U.S. Cl. 463/22

(57) ABSTRACT

The invention is similar to the Video Poker game where a single player is playing against oneself or the machine. The standard 52 poker cards are used. When playing against oneself, after placing the bet, the cards are shuffled and 6 cards are dealt face-up and displayed on the video screen. The player starts by drawing the 7th card from the remaining deck. The objective is to come up with a 7-card hand with the winning combination. The winning pattern consists of 2 cards of the same ranking (a Pair) and 5 cards of the poker hand (Royal Flush, Straight Flush, Four-of-a-Kind, Full House, Flush and Straight). If the 7 cards displayed on the video screen are one of the winning combinations, the player collects the assigned payout based on his bet. If the 7 cards are not the winning hand, the player can discard a card and a replacement card is dealt from the remaining 52-card deck. The same process will continue till the player attains the winning hand or the player has exhausted the allotted 7 tries and thus, loses his bet. When playing against the machine, 6 cards are also dealt to the machine face-down. The player and machine are then take turns to draw and discard cards till either one attains the 7 cards with the winning hand. The machine is programmed to play the game with the optimal skill. The player and the machine have equal chance to win the game. The player wins the bet if the player attains the winning hand first before the 7^{th} tries.

### REFERENCES CITED

### U.S. Patent Documents

| 6,729,621 B2 | May 4, 2004 | Ernest W. Moody |
|---|---|---|
| 6,748,675 B1 | Nov. 12, 2002 | Yehia Awada |
| 6,045,129 | Apr. 4, 2000 | Dual Cooper et al. |
| 5,882,259 | Mar. 16, 1999 | Verne F. Holmes et al. |
| 4,743,022 | May 10, 1988 | Michael W. Wood |

### BACKGROUND OF THE INVENTION

The Mahjong originated in China is played by four players. It is a game of skill, strategy and calculation. It is also a game of chance. In Asia, Mahjong is also popularly and leisurely played as a gambling game among friends and house wives. The game is played with a set of some 152 attractive tiles based on the Chinese characters and symbols. Each player begins by drawing thirteen tiles, one after the other. In turn, players draw and discard tiles until they complete a winning hand using the fourteenth drawn tile to form four groups of three tiles each and a pair of two tiles. The winner collects a wager from each player depending on the specific winning hand. It is calculated based on the specific patterns of the four groups of three tiles. Due to the large possible variations (thirteen tiles verse five cards, 152 tiles verse 52 cards); it takes a long time for the novice to master the game and the wager system. It also takes a comparatively long time to complete one round of the game.

Poker is a five-card vying game played with the standard 52 poker cards. A vying game is one where, instead of playing their cards out, the players bet as to who holds the best card combination by progressively raising the stakes during each round as the cards are dealt. If more than one player remains, there is a showdown, in which the players reveal their previously hidden cards and evaluate their hands. The player with the best hand according to the poker variant being played wins the pot. A poker hand comprises five cards; in the variants where a player has more than five cards the best five cards play. At any time during a betting round, if one player bets and no opponents choose to call the bet and instead fold, the hand ends immediately, the bettor is awarded the pot, no cards are required to be shown, and the next hand begins. This is what makes bluffing possible. Bluffing is a primary feature of poker. The different categories of five-card poker hands are as follows, from weakest to highest: One Pair, Two Pair, Three of a kind, Straight, Flush, Full house, Four of a kind, Straight flush and Royal flush.

Video Poker has been around for a long time (since 1970). It is played on an electronic machine with a display video screen. In one version, the Draw Poker, the game is started by displaying five cards on the video screen from a shuffled standard 52 poker cards. The player checks if the five cards are one of the winning poker hands and has the choice to discard anyone of the five cards (by touching the on-screen button below each card). The Video Poker machine then replaces the discard card/cards from the remaining deck. The resulting five cards are used to determine the payout according to the categories of five-card poker hands which are usually also displayed on the video screen along with the odds. For example, Royal Flush has a large payout of 1000 times the bet due to long odds, while One Pair has a small payout of 1 times the bet.

### BRIEF SUMMARY OF THE INVENTION

The 7 Cards Poker-Mahjong Video Game combines unique features from the Chinese Mahjong and the Video Poker card game. It uses the standard 52 poker cards, adopts the simple 5-card poker winning patterns, and utilizes Mahjong's requirement of skill and strategy. It is still a game of chance but engages the player in more thought process and choices. Here, two versions of the game to be played on a video machine are described.

In version one where the player plays against oneself, six cards are initially displayed face-up on the video screen. The player starts by drawing a card from the remaining deck to check if the 7 cards are one of the winning patterns which are also displayed on the video screen. If not, the player can discard one card and draw a replacement card. This process can be repeated only for 7 times. If the player does not have a winning hand at the end of 7 tries, the bet is lost.

In version two where the player plays against the machine, six cards for the player are initially displayed face-up and six cards for the machine are displayed face-down on the video screen. The player starts by drawing a card from the remaining deck to check if the 7 cards are one of the winning patterns. If not, the player discards one card and waits for the machine's turn to play. The machine either takes the card from the player's discarded card or draws the next card from the remaining deck. The machine then checks if the 7 cards are one of the winning patterns. If not, the machine discards one card. Now, the player can either take the machine's discarded card or draw the next card from the remaining deck. The process is repeated till a winning hand is attained or after 7 rounds.

This invention is about a method of playing a new card game where a single player plays against oneself or the machine similar to the Video Poker machine. Most of today's Video Poker machine employed in the gaming establishments are implemented with colorful displays and touch screen technology. These features can be easily reprogrammed to accommodate the 7 cards Poker-Mahjong Video game.

### BRIEF DESCRIPTION OF THE DRAWINGS

There are fourteen drawings used to help in describing this invention. They are explained below:

FIG. 1 shows the layout of the video game display on the screen. The player starts to play the game by touching the Start Game button shown by the arrow;

FIG. 2 shows that six cards (AS-4C-2D-8D-7H-JD) are dealt and displayed on the screen face-up;

FIG. 3 shows that the player needs to touch the Draw Card button to get the 7^{th} card;

FIG. 4 shows that JS is dealt and displayed after the Draw Card button is touched;

FIG. 5 shows that the player can stop the game by touching the Stop Game button;

FIG. 6 shows that the player discards the 7H by touching the Discard button below the card;

FIG. 7 shows the 7H is moved to the Discards row and an empty space is left where the card was located;

FIG. 8 shows that the player touches the Draw Card button to get a replacement card for the 7H. The replacement card turns out to be 2C;

FIG. 9 shows that after 7 tries of discard and draw a card, the game is over since the player has not attain the winning hand;

FIG. 10A shows a 7-card hand of 2H-KC-2D-3C-4S-3H-AD to start a new game;

FIG. 10B shows that the 2^{nd} card of KC is discarded and the replacement card is 4C;

FIG. 10C shows that the 7th card of AD is discarded and the replacement card is 6C;

FIG. 10D shows that the 7th card of 6C is discarded and the replacement card is 2C;

FIG. 10E shows that the player has attained a winning hand of Full-House, 2H-2D-2C-4S-4C-3C-3H. The player touches the Stop Game button to terminate the game to collect the payout pointed to by the arrow;

FIG. 11 shows that when the player touches the Start Game button, six cards for the player are displayed face-up and six cards for the machine are displayed face-down on the video screen.

FIG. 12 shows that when the player touches the Draw Card button, 9D is drawn from the deck and displayed n the video screen.

FIG. 13 shows that when the player discards one card by touching the Discard button below the card and the machine takes the player's discarded card of 3C and discards 7C.

FIG. 14 shows that when the player touches the Draw Card button to get the next card (JC) from the remaining deck.

FIG. 15 shows that when the player touches the Discard button to discards JC which is taken by the machine. The machine then discards 10D.

FIG. 16 shows that when the player touches the Draw Card button to get the next card (9S) from the remaining deck.

FIG. 17 shows that when the player touches the Discard button to discards 9S. The machine then draws the next card from the remaining deck and discards 4S.

FIG. 18 shows that the player takes the discarded card (4S) from the machine by touching the Draw Discard button. The player then discards 9D. The machine draws the next card from the remaining deck and discards 5H.

FIG. 19 shows that the player discards 9D. The machine draws the next card from the remaining deck and discards 5H.

FIG. 20 shows that the player takes the discarded card (5H) from the machine by touching the Draw Discard button.

FIG. 21 shows that the player touches the Stop Game button to stop the game with a winning hand of Flush, 4S-4H-AH-10H-9H-2H-5H.

### DETAILED DESCRIPTION OF THE INVENTION

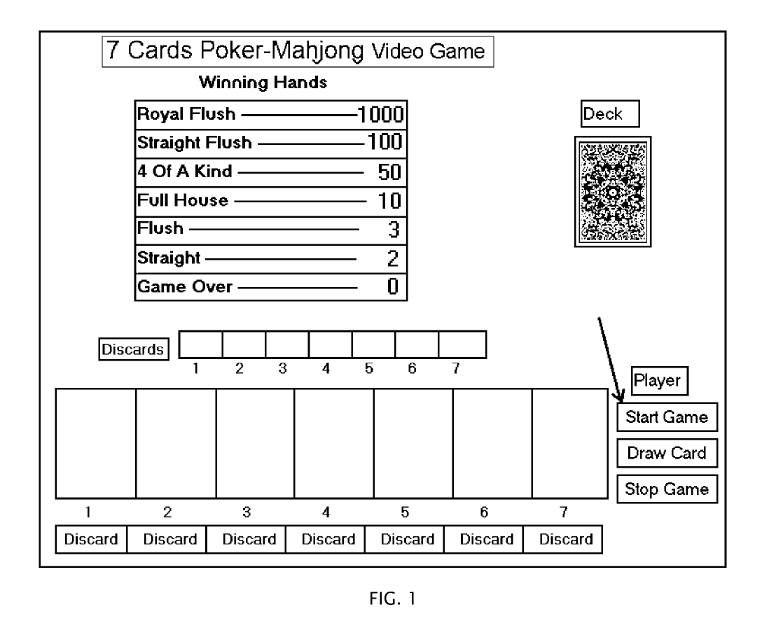

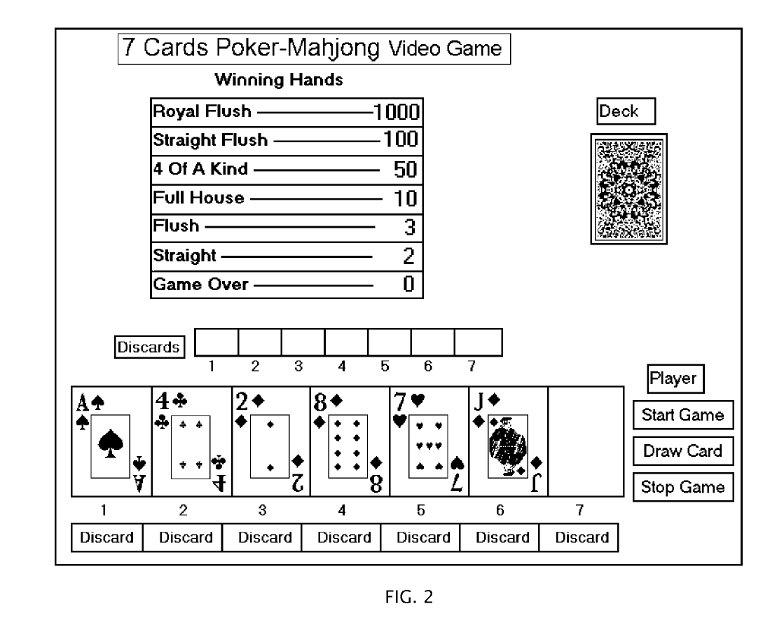

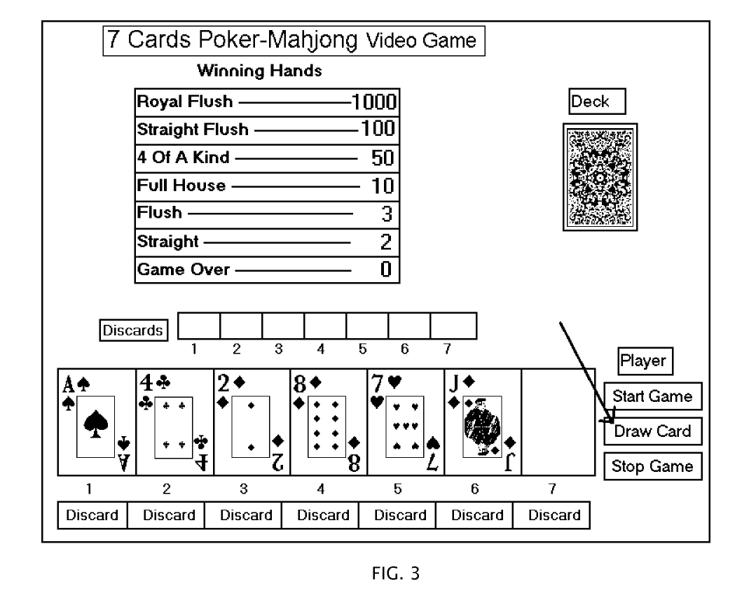

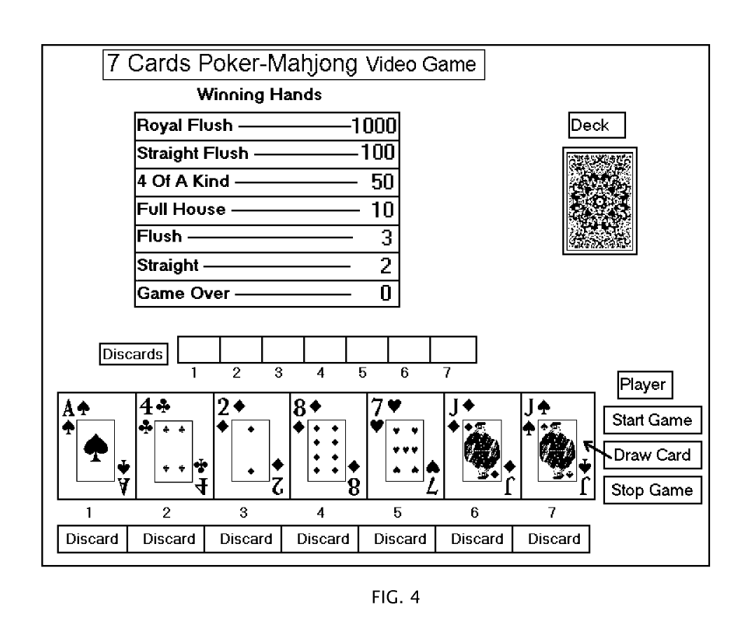

In version one, after placing the bet, the player touches the Start Game button (FIG. 1) to instruct the machine to shuffle the cards and display the first 6 cards face-up on the screen (FIG. 2). After the player has review the 6 cards, the player touches the Draw Card button (FIG. 3) to instruct the machine to deal the next card from the deck and display as the 7^{th} card face-up on the screen (FIG. 4).

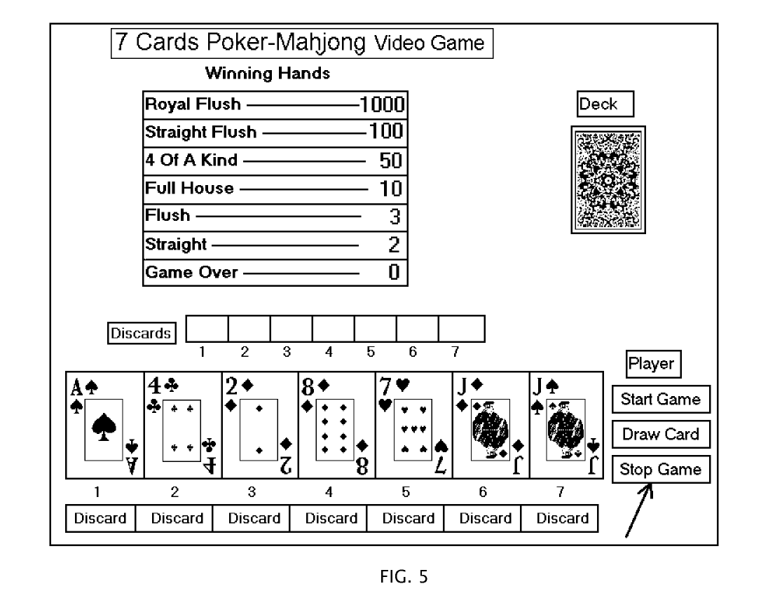

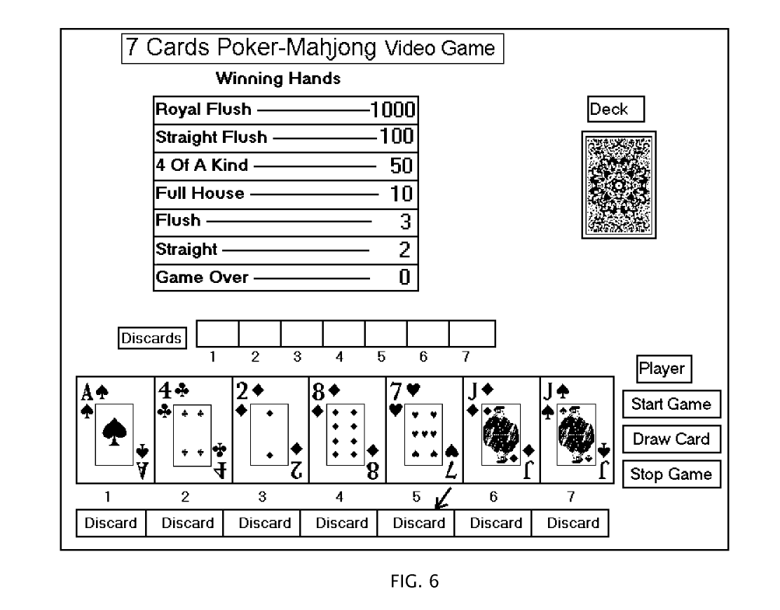

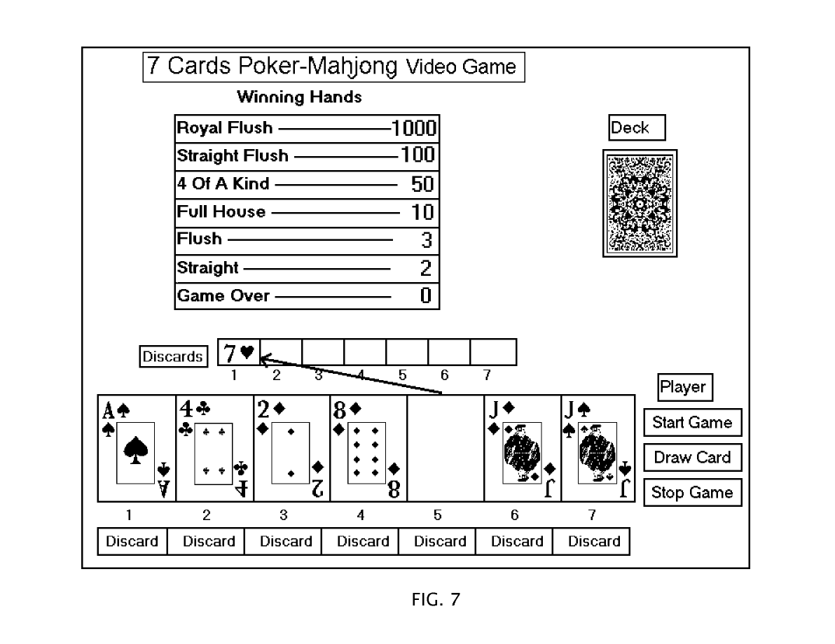

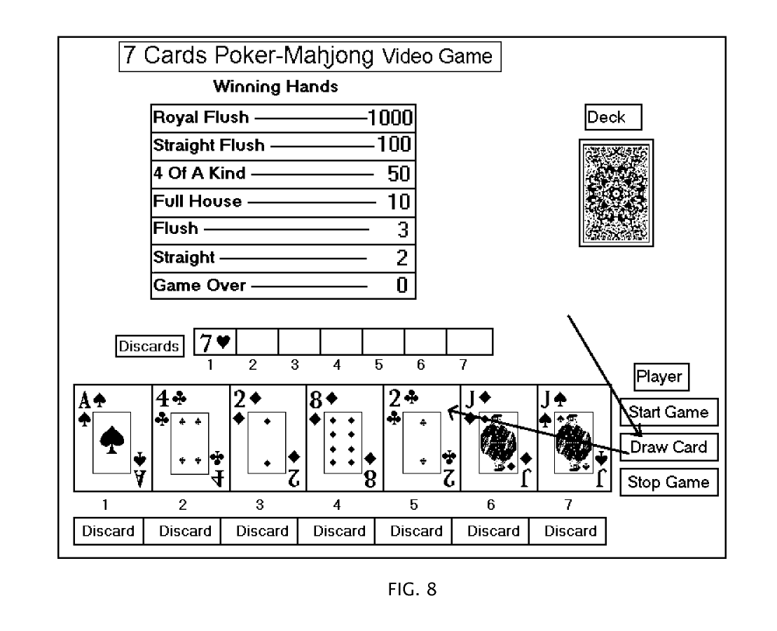

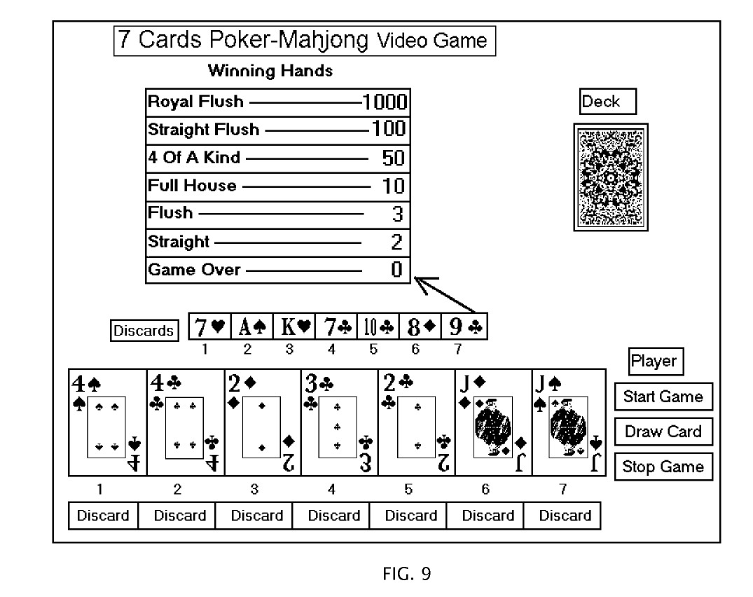

With seven cards displayed on the screen, the player checks if it is the winning hand (described below). If it is, the player touches the Stop Game button to terminate the game and receive the assigned payout (FIG. 5). If it is not, the player touches one of the Discard buttons to discard one card (FIG. 6). The discarded card will appear in the space to the right of the Discards label and an empty space will be left at where the discarded card was (FIG. 7). Now, only 6 cards are displayed. The player then touches the Draw Card button again to instruct the machine to deal the next card from the remaining deck to replace the discarded card (FIG. 8). The above steps are repeated till either a winning hand is attained or 7 tries have been attempted. If the latter occurs, the game is over with the Game Over Label lighted up. In this case, the player loses the bet (FIG. 9).

The 7 cards winning hand are:

A PAIR, two cards with the same ranking;

The remaining 5 cards have to be in one of the following Poker combination:

a) STRAIGHT—five cards in ranking sequence of different suits;

b) FLUSH—five cards of the same suit of random ranking sequence;

c) FULL-HOUSE—three cards of the same rank and two cards of the same rank;

d) FOUR-OF-A-KIND—four cards of the same rank with one card of anything;

e) STRAIGHT-FLUSH—five cards in ranking sequence of the same suit with no Ace;

f) ROYAL-FLUSH—Ace, King, Queen, Jack and 10 in ranking sequence of the same suit.

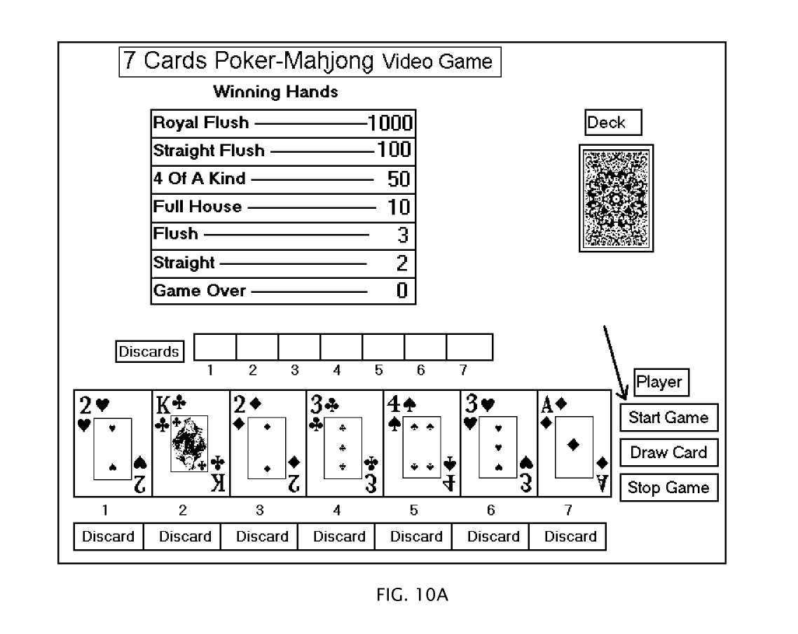

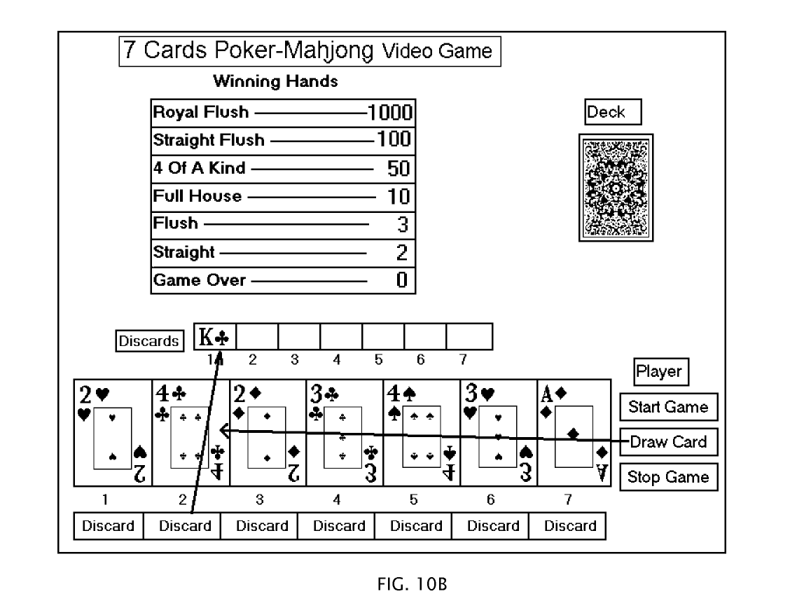

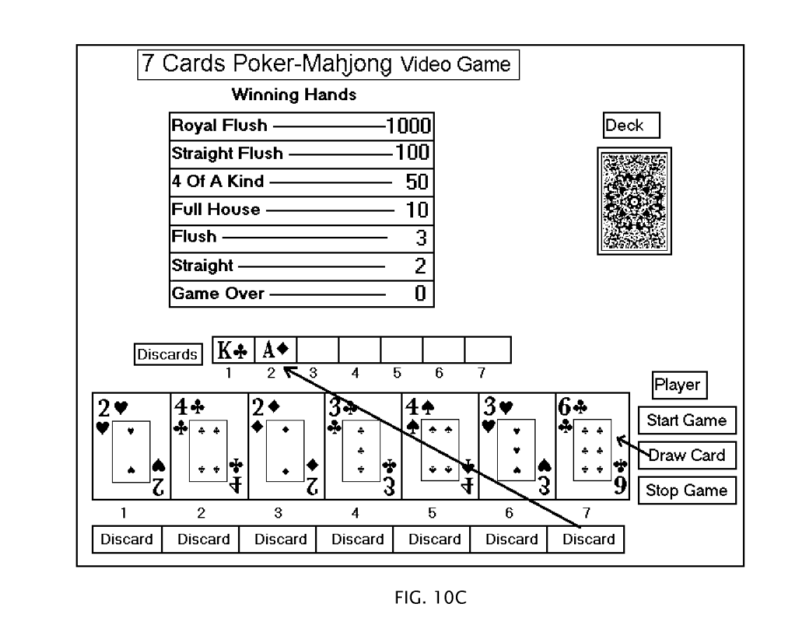

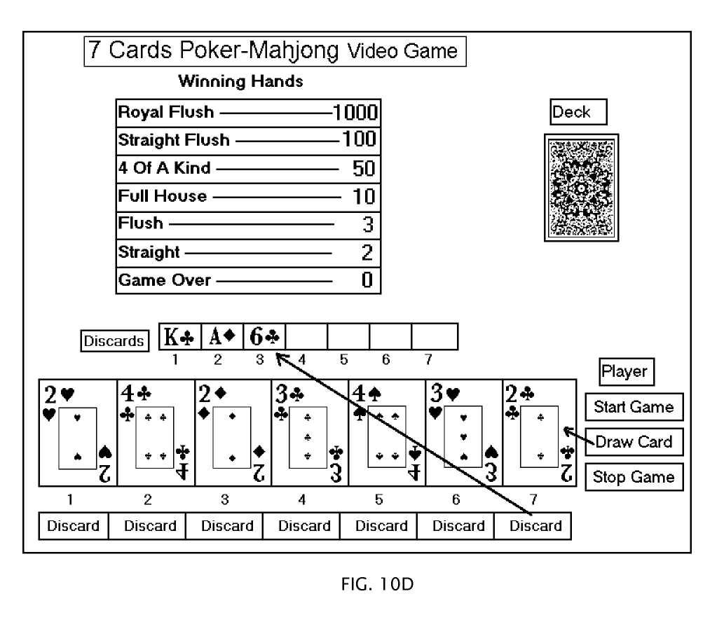

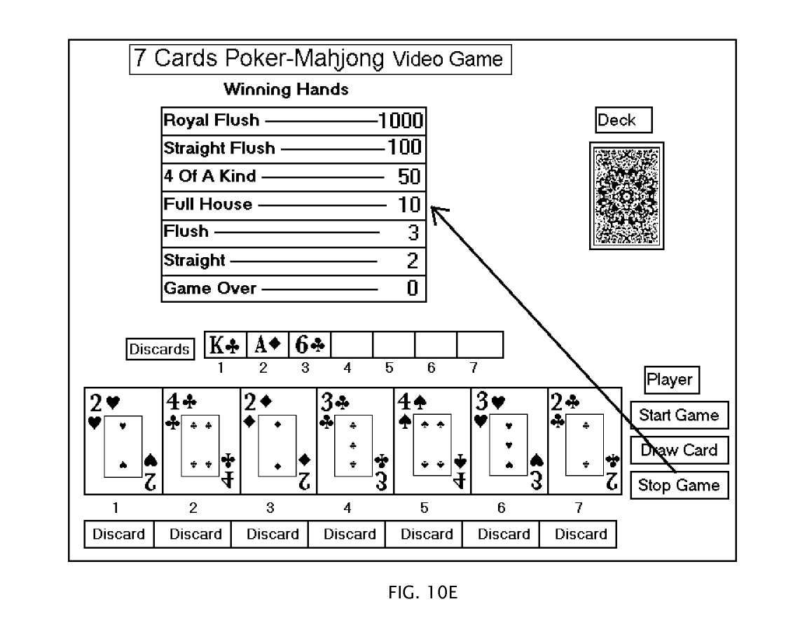

The basic strategy to achieve a winning hand is first to review the 6 cards to see how close it is to one of the six winning patterns (Straight, Flush, Full House, Four of a Kind, Straight Flush and Royal Flush). Straight or Flush is easier to attain but the payout is also smaller. FIG. 10A shows a 7-card hand of 2H-KC-2D-3C-4S-3H-AD. Since there are already two PAIRs and only KC is the higher ranking card all by itself, KC is discarded. FIG. 10B shows the replacement to be 4C. Now, there are three PAIRs and the logical discard is AD. FIG. 10C shows the replacement to be 6C. Since the hand has a better chance to attain Full-House, 6C is discarded. FIG. 10D shows the replacement to be 2C and thus, produce a winning hand of Full-House, 2H-2D-2C-4S-4C-3C-3H. Since the player has four more tries left, the player can either take the payout by touching the Stop Game button as shown in FIG. 10E, or discard a card (3's or 4's) to continue the game hoping to get a better payout of 4-Of-A-Kind if 2S appears. Of course, the player is also risking losing all.

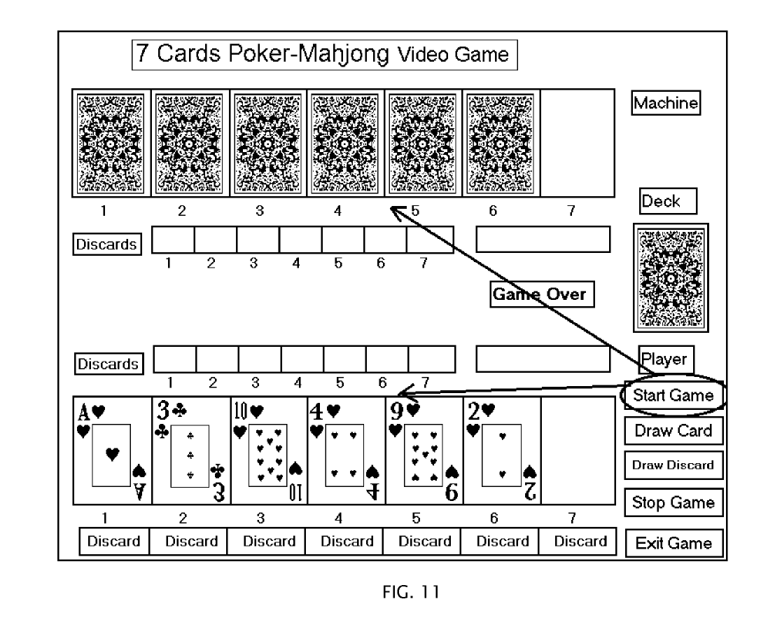

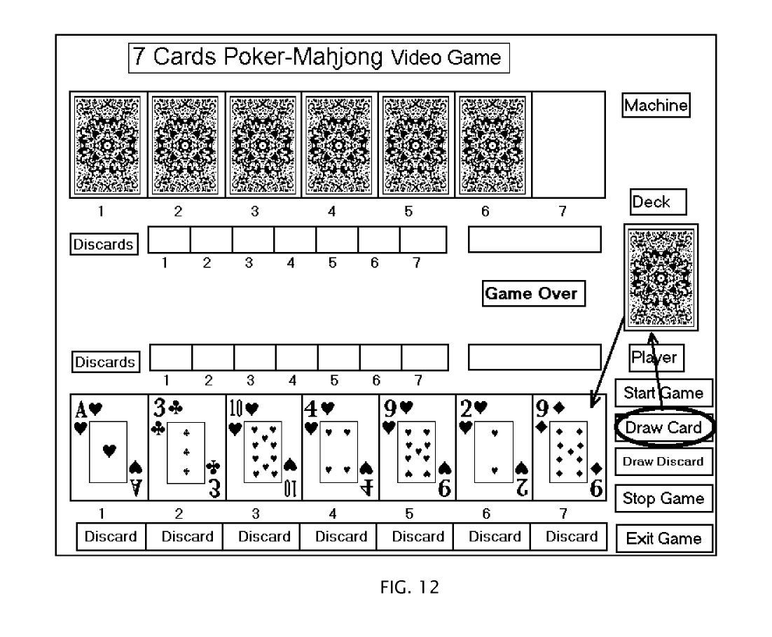

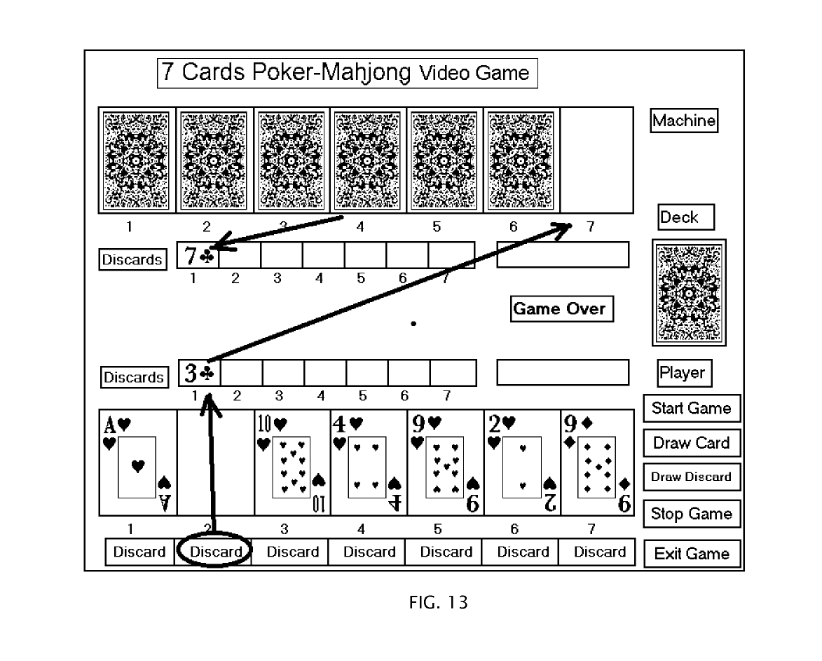

In version two, after placing the bet, the player touches the Start Game button (FIG. 11) to instruct the machine to shuffle the cards and display six cards for the player face-up and six cards for the machine face-down on the video screen. After the player has review the 6 cards, the player touches the Draw Card button (FIG. 12) to instruct the machine to deal the next card from the deck and display as the 7^{th} card face-up on the screen. The player checks if the 7 cards are one of the winning patterns. If not, the player discards one card by touching the Discard button (FIG. 13) and waits for the machine's turn to play. In this case, the machine takes the player's discarded card of 3C and discards 7C.

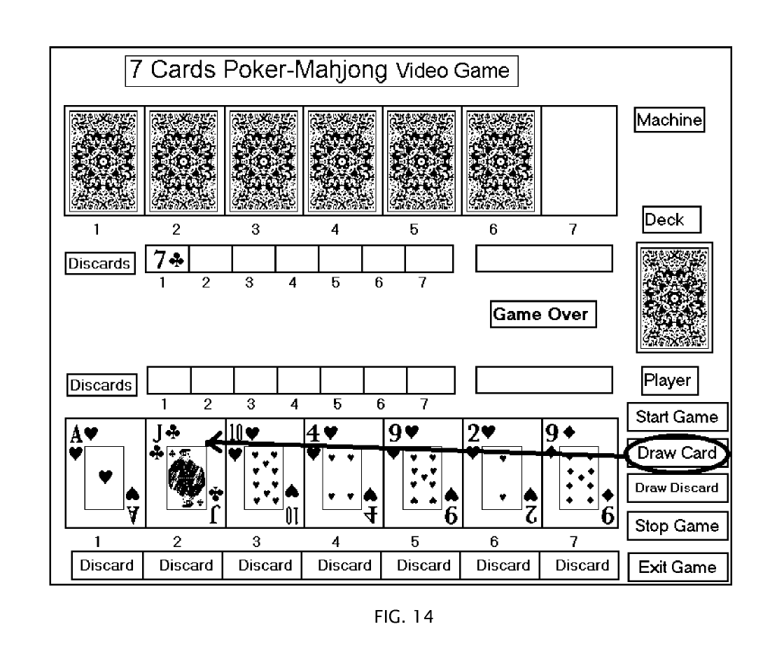

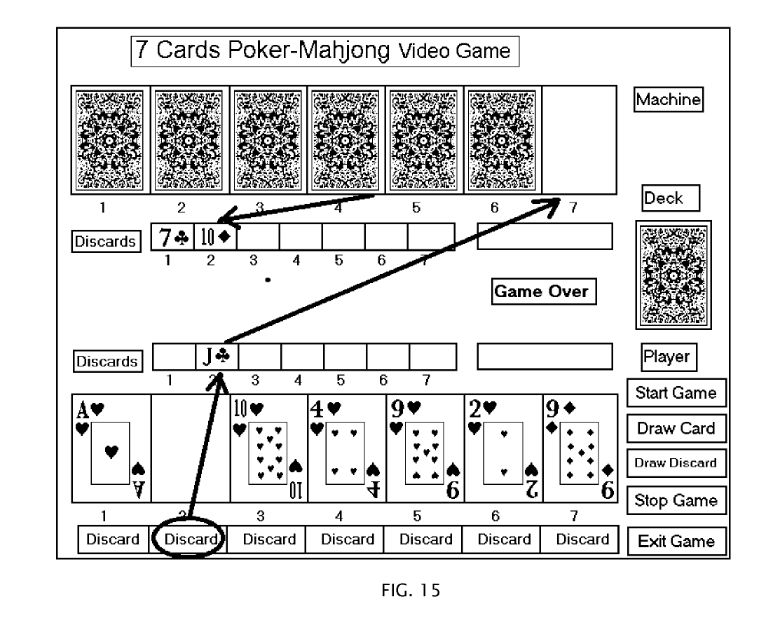

Since the player has no use of the machine's 7C, the player touches the Draw Card button to get the next card (JC) from the deck (FIG. 14). After checking the 7 cards for winning pattern, the player discards JC which is again taken by the machine. The machine then discards 10D (FIG. 15).

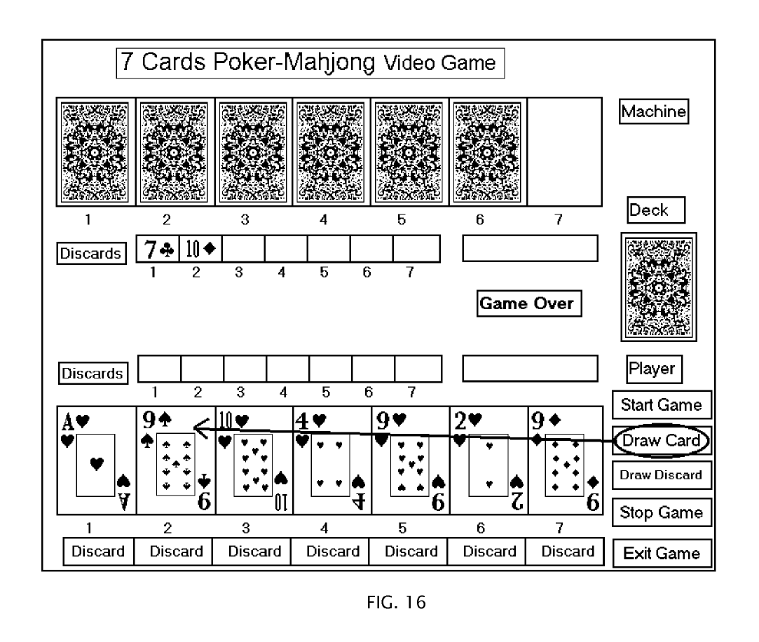

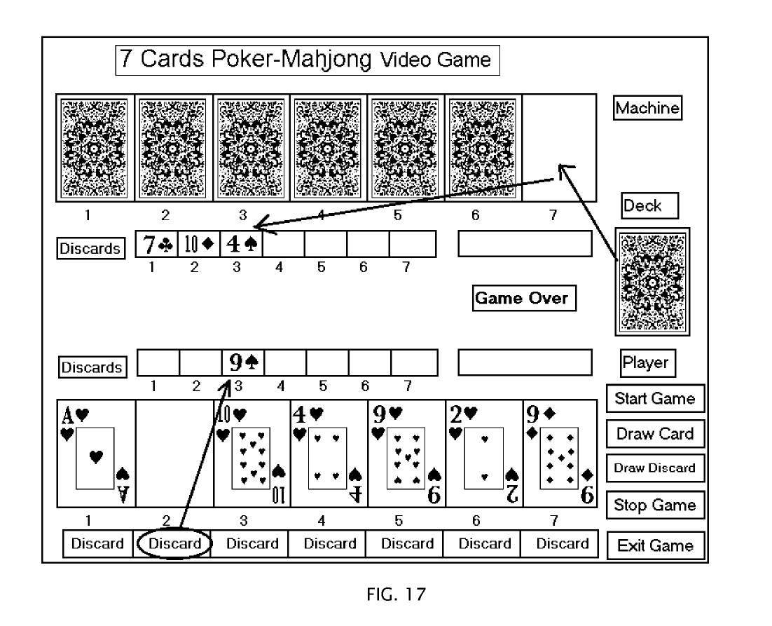

Since the player has no use of the machine's 10D, the player touches the Draw Card button to get the next card (9S) from the deck (FIG. 16). After checking the 7 cards for winning pattern, the player discards 9S. The machine draws the next card from the remaining deck then discards 4S (FIG. 17).

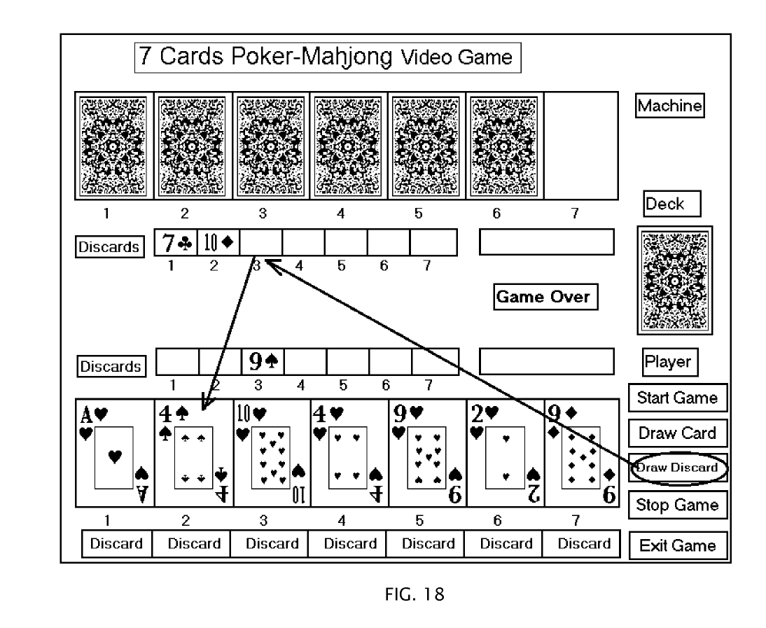

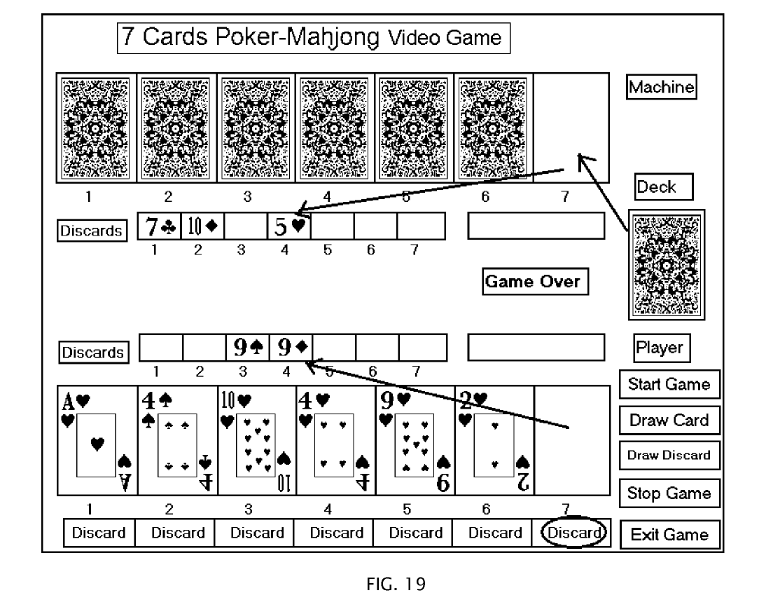

The player takes the discarded card (4S) from the machine by touching the Draw Discard button (FIG. 18). Now, the player has a Pair (4S and 4H). After checking the 7 cards for winning pattern, the player discards 9D. The machine draws the next card from the remaining deck then discards 5H (FIG. 19).

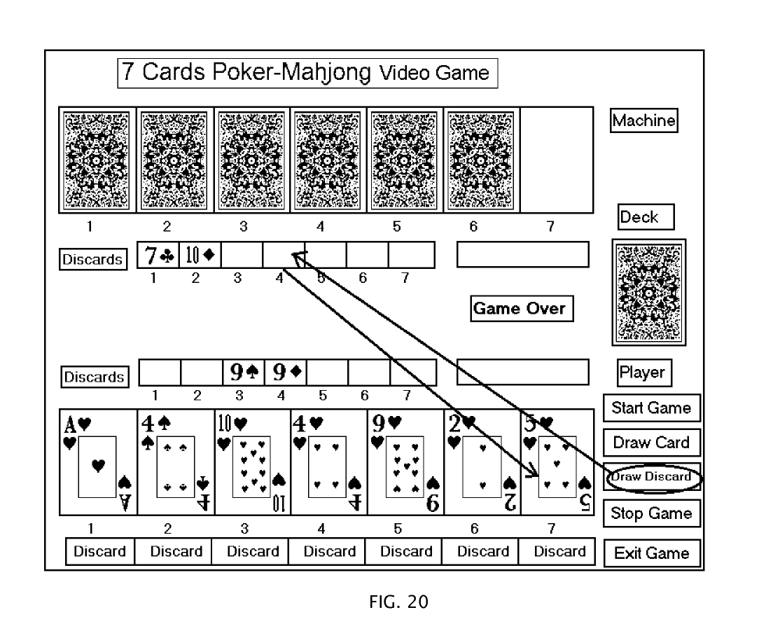

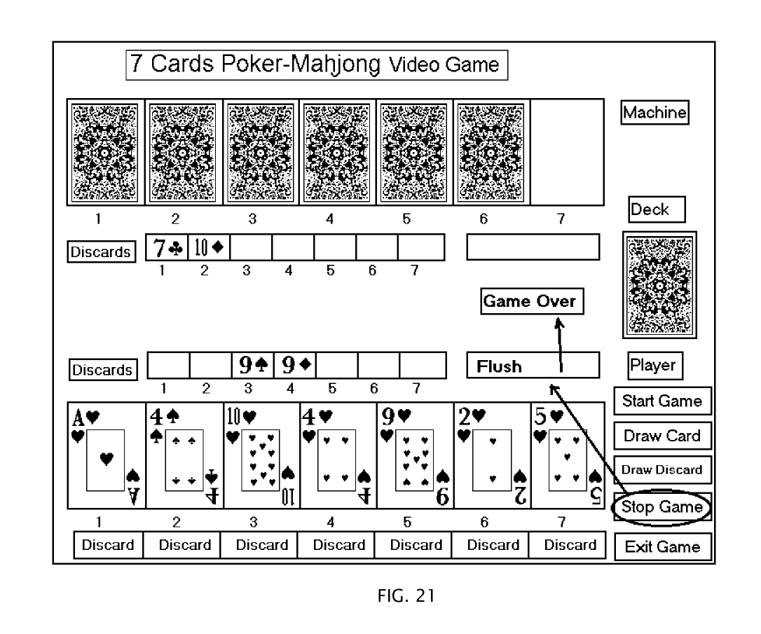

The player takes the discarded card (5H) from the machine by touching the Draw Discard button (FIG. 20). Now, the player has a Pair (4S and 4H) and five cards of the same suit (Heart). After checking the 7 cards for winning pattern, the player touches the Stop Game button (FIG. 21) to stop the game with a winning hand of Flush.

What I claim as my invention is:

1. A method of playing a game using the standard 52 poker cards on a video machine where:
a) only one player can participate and place a bet;
b) the player is allowed to start the game whereupon six cards are displayed face-up on the video screen after the 52 cards are shuffled;
c) the player is allowed to get the 7^{th} card from the remaining 52-card deck to be displayed on the video screen face-up;
d) the player checks if the 7-card combination is one of the winning hands;
e) if the 7-card combination is the winning hand, the player is allowed to stop the game and collect the payout according to the bet;
f) if the 7-card combination is not the winning hand, the player is allowed to discard a card and a new card is dealt from the remaining 52-card deck to replace the discarded card;
g) the above steps d) to f) are repeated till either a winning hand is attained or 7 tries have been attempted by the player. If the latter occurs, the game is over and the player loses the bet.

2. The method of claim 1 further comprising that the 7-card winning hands are defined as followed:
A PAIR, two cards with the same ranking;
The remaining 5 cards have to be in one of the following Poker combination:
a) STRAIGHT—five cards in ranking sequence of different suits;
b) FLUSH—five cards of the same suit of random ranking sequence;
c) FULL-HOUSE—three cards of the same rank and two cards of the same rank;
d) FOUR-OF-A-KIND—four cards of the same rank with one card of anything;
e) STRAIGHT-FLUSH—five cards in ranking sequence of the same suit with no Ace;
f) ROYAL-FLUSH—Ace, King, Queen, Jack and 10 in ranking sequence of the same suit.

3. The method of claim 1 further comprising that the player with the winning hand collects a payout to be displayed on the video screen based on the table below:

| | |
|---|---|
| a) ROYAL-FLUSH: | 1000 for 1 |
| b) STRAIGHT-FLUSH: | 100 for 1 |
| c) FOUR-OF-A-KIND: | 50 for 1 |
| d) FULL-HOUSE: | 10 for 1 |
| e) FLUSH: | 3 for 1 |
| f) STRAIGHT: | 2 for 1 |

4. A video machine for playing a game in accordance with the method in claim 1.

5. A method of playing a game using the standard 52 poker cards on a video machine where:
a) only one player can participate and place a bet;
b) the player is allowed to start the game whereupon six cards are displayed face-up for the player and six cards are displayed face-down for the machine on the video screen after the 52 cards are shuffled;
c) the player is allowed to get the 7^{th} card from the remaining 52-card deck to be displayed on the video screen face-up;
d) the player checks if the 7-card combination is one of the winning hands;
e) if the 7-card combination is the winning hand, the player is allowed to stop the game and collect the payout according to the bet;
f) if the 7-card combination is not the winning hand, the player is allowed to discard a card and the machine is then allowed to either take the card from the player's discard or draws the next card from the remaining deck;
g) the player is allowed to either take the machine's discarded card or draw the next card from the remaining deck.
h) the above steps d) to g) are repeated till either a winning hand is attained by the player or the machine or 7 tries have been attempted by the player. If the latter two conditions occur, the game is over and the player loses the bet.

6. The method of claim 5 further comprising that the 7-card winning hands are defined as followed:
A PAIR, two cards with the same ranking;
The remaining 5 cards have to be in one of the following Poker combination:
a) STRAIGHT—five cards in ranking sequence of different suits;
b) FLUSH—five cards of the same suit of random ranking sequence;
c) FULL-HOUSE—three cards of the same rank and two cards of the same rank;
d) FOUR-OF-A-KIND—four cards of the same rank with one card of anything;
e) STRAIGHT-FLUSH—five cards in ranking sequence of the same suit with no Ace;
f) ROYAL-FLUSH—Ace, King, Queen, Jack and 10 in ranking sequence of the same suit.

7. The method of claim 1 further comprising that the player with the winning hand collects a payout based on the table below:

| | |
|---|---|
| a) ROYAL-FLUSH: | 1000 for 1 |
| b) STRAIGHT-FLUSH: | 100 for 1 |
| c) FOUR-OF-A-KIND: | 50 for 1 |
| d) FULL-HOUSE: | 10 for 1 |
| e) FLUSH: | 3 for 1 |
| f) STRAIGHT: | 2 for 1 |

8. A video machine for playing a game in accordance with the method in claim 5.
